(19) United States
(12) Patent Application Publication
(10) Pub. No.: US 2017/0034781 A1
(43) Pub. Date: Feb. 2, 2017

(54) METHOD OF ENHANCING UPLINK TRANSMISSION HANDLING IN A DISCONTINUOUS RECEPTION (DRX) MODE OF A USER EQUIPMENT

(71) Applicant: Samsung Electronics Co., Ltd., Gyeonggi-do (KR)

(72) Inventors: Rohit KUMAR, Bangalore (IN); Swapnil Vinod KHACHANE, Bangalore (IN)

(73) Assignee: Samsung Electronics Co., Ltd.

(21) Appl. No.: 14/849,216

(22) Filed: Sep. 9, 2015

(30) Foreign Application Priority Data
Jul. 30, 2015 (IN) 3935/CHE/2015

(51) Int. Cl. H04W 52/02; H04W 72/12; H04W 76/04

(52) U.S. Cl. CPC H04W 52/0229; H04W 76/048; H04W 72/1289; H04W 52/028

(57) ABSTRACT

A User Equipment (UE) and a method for enhancing uplink transmission handling in Discontinuous Reception (DRX) mode of the UE are provided. The method includes of receiving, by the UE, an uplink data transmission request in the DRX mode; computing a first transition time and a first Scheduling Request (SR) transition time; calculating a second transition time; determining if the second transition time is less than a third transition time; computing a wakeup transition time, if the second transition time is not less than the third transition time; and enhancing uplink transmission time by triggering a wakeup procedure for the UE at a fourth transition time.

### PRIORITY

This application claims priority under 35 U.S.C. §119(a) to Indian Patent Application Ser. No. 3935/CHE/2015, which was filed in the Indian Property Office on Jul. 30, 2015, the entire disclosure of which is incorporated herein by reference.

### BACKGROUND

1. Field of the Disclosure

The present disclosure relates generally to telecommunication, and more particularly, to a method of enhanced uplink transmission using a scheduling request or a random access channel.

2. Description of the Related Art

Long Term Evolution (LTE) wireless communication supports only packet-switched transmission, and tends to implement a Medium Access Control (MAC) layer and a Radio Link Control (RLC) layer in base stations (or Node Bs) alone, rather than in base stations and Radio Network Controllers (RNCs), thereby providing a simplified system architecture.

Specifically, in an LTE system, a base station (or an evolved Node B (eNB)) performs radio resource allocation in order to provide User Equipments (UEs) with resources for uplink or downlink transmissions. Generally, there are two kinds of resource allocations: 1) dynamic resource allocation, and 2) pre-configured resource allocation.

For the pre-configured resource allocation, the base station allocates radio resources to the UEs using Radio Resource Control (RRC) signaling. Based on the allocated radio resources, the UEs transmit and/or receive certain amounts of data at periodic time intervals, in order to exchange data with the base station.

However, for the dynamic resource allocation, the base station dynamically allocates radio resources to the UEs, depending on the number of UEs located in a cell area of the base station, traffic volume, and quality of service (QoS) requirements of each UE. The UEs monitor a physical downlink control channel (PDCCH) to identify possible allocation of dynamic resources for transmitting and receiving data.

In the Third Generation Partnership Project (3GPP), discontinuous reception (DRX) is used between the base station and the UE to save the battery power of UE. Basically, the UE is configured by an RRC/MAC with a DRX functionality, which that allows the UE to stop monitoring a PDCCH for a period of time (i.e., a sleep period) based on a DRX cycle. Generally, a long DRX cycle provides a longer sleep period for the UE, than a short DRX cycle.

In LTE, a UE requests a grant for an uplink transmission from an eNodeB using a Scheduling Request (SR) or a Random Access Channel (RACH). However, a problem arises when the UE is operating in a DRX mode and needs a grant for an uplink data transmission. The RACH and the SR have their own respective transmission opportunity times, and therefore, data will only be transmitted at the particular transmission opportunity times. Consequently, unnecessary battery consumption occurs in the DRX mode, when the UE does not initiate DRX sleep after the SR, when a RACH transmission is pending, or when the UE aborts the DRX sleep blindly to perform the SR or the RACH, without considering their transmission occasions and hardware stability transition time.

In addition to battery consumption problems, the UE must be in active state at the first SR or RACH opportunity at which it is possible to successfully transmit the SR or the RACH.

### SUMMARY

An aspect of the present disclosure is to provide a UE and a method thereof, where the UE accurately computes extra sleep time before a first possible successful SR or RACH transmission, in order to reduce battery consumption.

Another aspect of the present disclosure is to provide a method and system for enhancing uplink transmission handling in a DRX mode of a UE.

According to another embodiment of the present invention, a method is provided for enhancing uplink transmission handling in a DRX mode of a UE. The method includes receiving, by the UE, an uplink data transmission request in the DRX mode; computing a first SR transition time; computing a first transition time; determining if a first scheduling request is served; computing a wakeup transition time, if the first scheduling request is not served; and enhancing the uplink transmission by triggering a wakeup procedure for the UE at a second transition time.

According to another embodiment of the present invention, a User Equipment (UE) is provided, which includes a transceiver configured to receive an uplink data transmission request; and a processor, in a DRX sleep mode, configured to compute a first transition time and a first

SR transition time, calculate a second transition time, determine if the second transition time is less than a third transition time, compute a wakeup transition time, if the second transition time is not less than the third transition time, and enhance an uplink transmission time by triggering a wakeup procedure for the UE at a fourth transition time.

### BRIEF DESCRIPTION OF THE DRAWINGS

The above and other aspects, features, and advantages of certain embodiments of the present disclosure will be more apparent from the following description when taken in conjunction with accompanying drawings, in which:

FIG. 1 is a flow chart illustrating a method for enhancing uplink data transmission handling during a DRX sleep mode of a UE, in accordance with an embodiment of the present disclosure;

FIG. 2 is a flow chart illustrating a method for enhancing uplink data transmission handling during a DRX Active mode of a UE, in accordance with an embodiment of the present disclosure; and

FIG. 3 illustrates a User Equipment, according to an embodiment of the present disclosure.

### DETAILED DESCRIPTION OF EMBODIMENTS

Various embodiments of the present disclosure are described in detail below with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

Herein, reference may be made to “an”, “one”, or “some” embodiment(s), which does not necessarily imply that each such reference is to the same embodiment(s), or that the feature only applies to a single embodiment. Single features of different embodiments may also be combined to provide other embodiments.

As used herein, the singular forms “a”, “an”, and “the” are intended to include the plural forms as well, unless expressly stated otherwise. It will be further understood that the terms “includes”, “comprises”, “including”, and/or “comprising”, when used herein, specify the presence of stated features, integers, steps, operations, elements, and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have meanings as commonly understood by one of ordinary skill in the art to which this disclosure pertains. It will be further understood that terms, such as those defined in commonly used dictionaries, should be interpreted as having meanings that are consistent with their meanings in the context of the relevant art, and should not be interpreted in idealized or overly formal senses, unless expressly defined as such herein.

The various embodiments described herein provide methods of computing an optimum sleep time based on a next SR/RACH opportunity of the UE, in order to reduce power consumption.

According to an embodiment of the present disclosure, a method is provided for an uplink transmission request in a sleep time of a UE and an uplink transmission request in an active time of the UE. Specifically, the UE may initiate a sleep mode for a computed extra sleep time, or remain in the sleep mode for the extra sleep time, if the UE is already in the sleep mode.

Basically, a UE operates in an active state or an inactive state. An inactive state (or an inactive time) of UE in a DRX is a duration for which no downlink data activity is expected. That is, UE sleeps (powers off/slows clock) during this duration. An active state (or active time) is when the UE is not in the inactive state. The time required for moving from sleep state to active state, i.e., a transition time between the two states, is commonly referred to as “hardware stability time”.

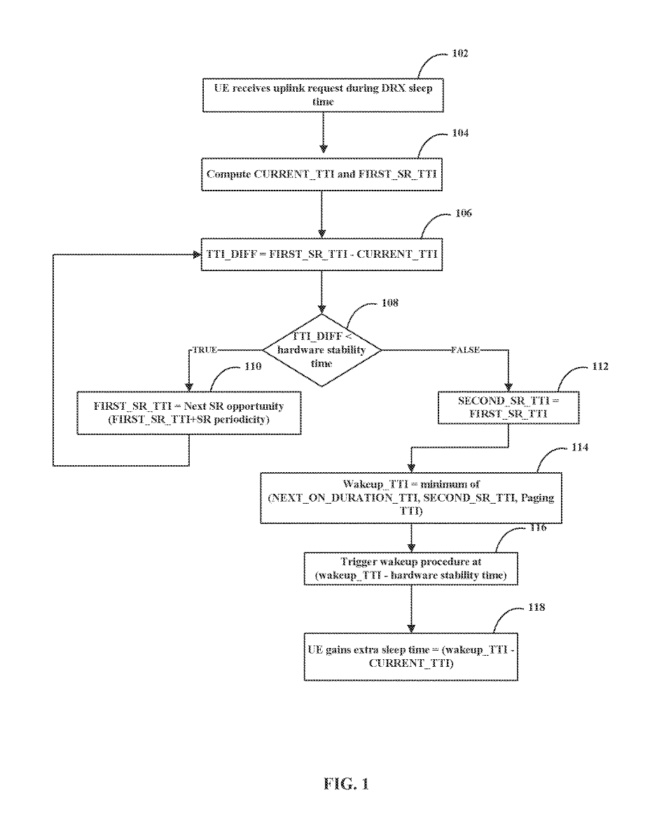

FIG. 1 is a flow chart illustrating a method for enhancing uplink data transmission handling during a DRX sleep mode of a UE, in accordance with an embodiment of the present disclosure.

Referring to FIG. 1, in step 102, the UE receives an uplink data transmission request during a DRX sleep mode.

In step 104, the UE computes a first transition time interval (CURRENT_TTI), which is a subframe (current time) and a time at which the uplink data transmission request is received, and computes a first scheduling request (SR) transition time interval (FIRST_SR_TTI), which is the first SR/RACH opportunity provided to the UE for a data transfer.

In step 106, the UE calculates a second transition time interval (TTI_DIFF), which represents a difference between the first scheduling request transition time (FIRST_SR_TTI) and the first transition time (CURRENT_TTI).

In step 108, the UE determines if the second transition time interval (TTI_DIFF) is less than a hardware stability time, i.e., the time required for transitioning from a sleep state to an active state.

If the second transition time interval (TTI_DIFF) is less than the hardware stability time, the SR/RACH cannot be transmitted at the first scheduling request transition time (FIRST_SR_TTI) opportunity. Therefore, in step 110, the UE re-computes the first scheduling request transition time (FIRST_SR_TTI) using a next SR/RACH opportunity (NEXT_SR_TTI), such that the second transition time interval (TTI_DIFF) calculated with the recalculated FIRST_SR_TTI and the CURRENT TTI is not less than the hardware stability time.

However, if the second transition time interval (TTI_DIFF) is not less than the hardware stability time, the UE assigns the first scheduling request transition time interval (FIRST_SR_TTI) as a next SR/RACH opportunity (SECOND _SR_TTI) in step 112.

In step 114, the wakeup transition time interval (wakeup_TTI) is computed as a minimum of a (NEXT_ON_DURATION_TTI), the (SECOND_SR_TTI), and a (Paging TTI), where the NEXT ON DURATION TTI is the transition time interval at which next DRX ON duration will start and PAGING TTI is the transition time interval at which next paging occasion is present.

In step 116, the UE calculates a time for triggering the wakeup procedure as a difference between the wakeup transition time interval (wakeup_TTI) and the hardware stability time. The time for triggering the wakeup procedure for the UE is set, such that the UE has enough time to transition from sleep state to active state.

In step 118, the UE gains extra sleep time, based on a difference between the wakeup transition time (wakeup_TTI) and the first transition time (CURRENT_TTI), thereby reducing the battery power consumption.

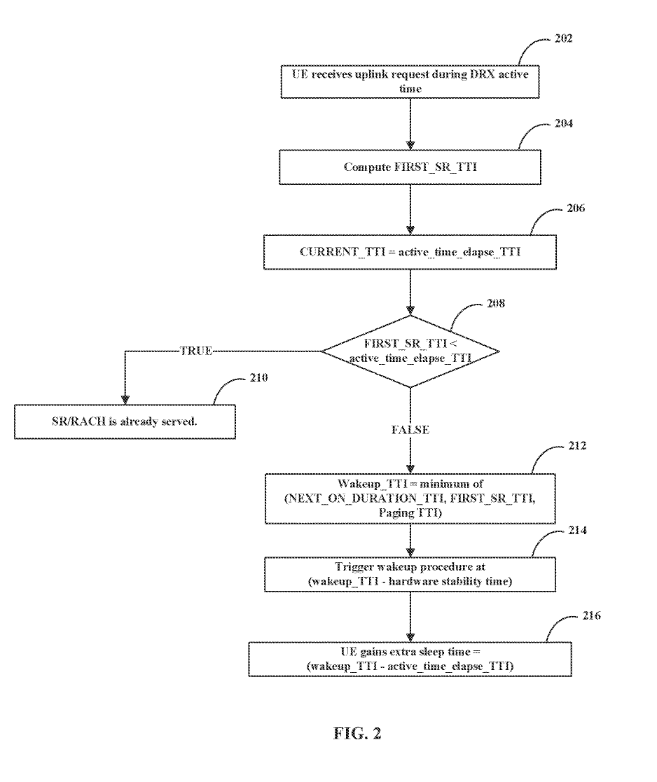

FIG. 2 is a flow chart illustrating a method for enhancing uplink data transmission handling during a DRX Active mode of a UE, in accordance with an embodiment of the present disclosure.

Referring to FIG. 2, in step 202, the UE receives an uplink data transmission request during DRX active mode.

In step 204, the UE computes the first SR transition time interval (FIRST_SR_TTI), i.e., the first SR/RACH opportunity provided to the UE for a data transfer.

In step 206, the Active time elapse transition time interval (active_time_elapse_TTI) is computed as the time at which DRX active time of the UE elapses, i.e., there is no activity between UE and Network. This is also the first transition time interval (CURRENT_TTI).

In step 208, the UE determines if the first SR transition time interval (FIRST_SR_TTI) is less than the active time elapse transition time interval (active_time_elapse_TTI).

If the first scheduling SR time interval (FIRST_SR_TTI) is less than the active time elapse transition time interval (active_time_elapse_TTI), the uplink data has been transmitted successfully, i.e., SR/RACH is already served, in step 210, and the UE remains in the DRX active mode, until the active time elapse transition time.

However, if the first SR transition time interval (FIRST_SR_TTI) is not less than the active time elapse transition time interval (active_time_elapse_TTI), the UE computes a wakeup transition time interval (wakeup_TTI) as a minimum of a (NEXT_ON_DURATION_TTI), the (FIRST_SR_TTI), and a (Paging TTI) in step 212.

In step 214, the UE calculates the triggering the wakeup procedure time as a difference between the wakeup transition time interval (wakeup_TTI) and the hardware stability time, i.e., the time required for transitioning from a sleep state to an active state.

As described above, the triggering the wakeup procedure time for the UE is set, such that the UE has enough time to transition from a sleep state to an active state.

In step 216, UE gains extra sleep time based on a difference between the wakeup transition time interval (wakeup_TTI) and active time elapse transition time interval (active_time_elapse_TTI), thereby reducing battery power consumption.

According to an embodiment herein, comparison of TTIs is based on the wraparound of a TTI. In 3GPP, a TTI is defined as 10*Sequence Frame Number (SFN)+subframe.

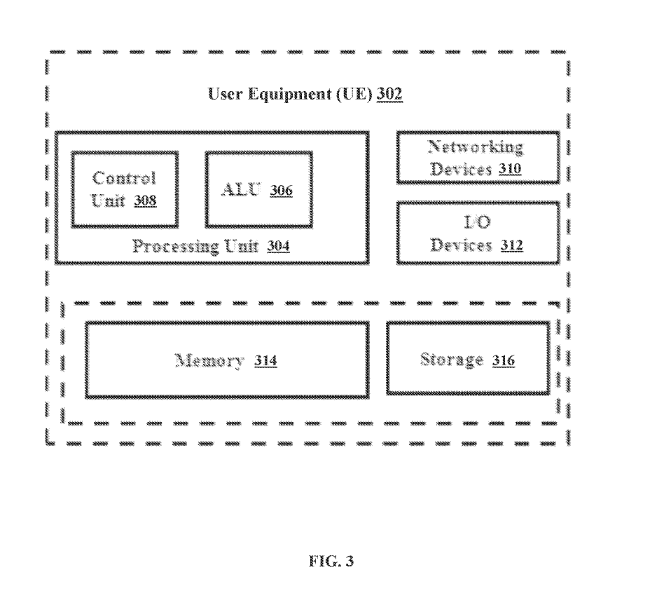

FIG. 3 illustrates a User Equipment, according to an embodiment of the present disclosure.

Referring to FIG. 3, a UE 302, which may implement the methods illustrated in FIGS. 1 and 2, includes a processing unit 304 including a control unit 308 and an Arithmetic Logic Unit (ALU) 306, a memory 314, a storage 316, a plurality of networking devices 310, and a plurality Input/Output (I/O) devices 312.

The processing unit 304 is responsible for processing instructions of an algorithm for performing the steps of the methods illustrated in FIGS. 1 and 2. The processing unit 304 may receive commands from the control unit 308, in order to perform the processing. Further, any logical and arithmetic operations involved in the execution of the instructions may be computed with the help of the ALU 306.

The UE 302 may include multiple homogeneous or heterogeneous cores, multiple Central

Processing Units (CPUs) of different kinds, special media, and other accelerators. Further, the plurality of processing unit 304 can be located on a single chip or over multiple chips.

The algorithm comprising of instructions and codes for the implementation of the methods illustrated in FIGS. 1 and 2 are stored in the memory 314, the storage 316, or both. At the time of execution, the instructions can be fetched from the corresponding memory 314 or storage 316, and executed by the processing unit 304.

Various networking devices 310, e.g., a transceiver, or external I/O devices 312 can be connected in the UE 302 to support the implementation of the methods illustrated in FIGS. 1 and 2.

The embodiments described herein can be implemented through at least one software program running on at least one hardware device and performing network management functions to control the elements. FIGS. 1 through 3 include blocks which can be at least one of a hardware device or a combination of hardware device and software module.

As described in the embodiments above, a method is provided for enhancing uplink transmission handling in a DRX mode of a UE. The method includes receiving, by the UE, an uplink data transmission request in the DRX mode; computing a first transition time and a first

Scheduling Request (SR) transition time; calculating a second transition time; determining if the second transition time is less than a third transition time; computing a wakeup transition time, if the second transition time is not less than the third transition time; and enhancing uplink transmission time by triggering a wakeup procedure for the UE at a fourth transition time.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method of enhancing uplink transmission handling in a Discontinuous Reception (DRX) mode of a User Equipment (UE), the method comprising:
receiving, by the UE, an uplink data transmission request in the DRX mode;
computing a first transition time and a first Scheduling Request (SR) transition time;
calculating a second transition time;
determining if the second transition time is less than a third transition time;
computing a wakeup transition time, if the second transition time is not less than the third transition time; and
enhancing uplink transmission time by triggering a wakeup procedure for the UE at a fourth transition time.

2. The method of claim 1, further comprising:
computing a next SR transition time, if the second transition time is less than the third transition time; and
recalculating the second transition time, based on the next SR transition time.

3. The method of claim 1, wherein the DRX mode is a DRX sleep mode.

4. The method of claim 1, wherein the second transition time is calculated by subtracting the first transition time from the first SR transition time.

5. The method of claim 1, wherein the wakeup transition time is computed from a minimum of a next on duration transmission time interval (TTI), a second SR transition time, and a Paging TTI.

6. The method of claim 1, wherein the third transition time is based on a time required for the UE to transition from a sleep state to an active state.

7. The method of claim 1, wherein the fourth transition time is calculated by subtracting the third transition time from the wakeup transition time.

8. A method of enhancing uplink transmission handling in a Discontinuous Reception (DRX) mode of a User Equipment (UE), the method comprising:
receiving, by the UE, an uplink data transmission request in the DRX mode;
computing a first Scheduling Request (SR) transition time;
computing a first transition time;
determining if a first scheduling request is served;
computing a wakeup transition time, if the first scheduling request is not served; and
enhancing uplink transmission time by triggering a wakeup procedure for the UE at a second transition time.

9. The method of claim 7, wherein the DRX mode is a DRX active period.

10. The method of claim 7, wherein the second transition time is calculated by subtracting a third transition time from the wakeup transition time.

11. The method of claim 7, wherein the third transition time is based on a time required for the UE to transition from a sleep state to an active state.

12. The method of claim 7, wherein the wakeup transition time is computed from a minimum of a next on duration transmission time interval (TTI), a second SR transition time, and a Paging TTI.

13. The method of claim 7, further comprising remaining in the DRX mode, if the first scheduling request is served.

14. A User Equipment (UE) comprising:
a transceiver configured to receive an uplink data transmission request; and
a processor, in a Discontinuous Reception (DRX) sleep mode, configured to compute a first transition time and a first Scheduling Request (SR) transition time, calculate a second transition time, determine if the second transition time is less than a third transition time, compute a wakeup transition time, if the second transition time is not less than the third transition time, and enhance an uplink transmission time by triggering a wakeup procedure for the UE at a fourth transition time.

15. The UE of claim 14, wherein the processor is further configured to compute a next SR transition time, if the second transition time is less than the third transition time, and recalculate the second transition time, based on the next SR transition time.

16. The UE of claim 14, wherein the processor, in a DRX active period, is further configured to:
compute a second SR transition time;
compute fifth first transition time;
determine if a second scheduling request is served;
compute the wakeup transition time, if the second scheduling request is not served; and
enhance the uplink transmission by triggering the wakeup procedure for the UE at a sixth transition time.

17. The UE of claim 14, wherein the processor is further configured to:
calculate the second transition time by subtracting the first transition time from the first SR transition time; and
compute the wakeup transition time from a minimum of a next on duration transmission time interval (TTI), a second SR transition time, and a Paging TTI.

18. The UE of claim 14, wherein the third transition time is based on a time required for the UE to transition from a sleep state to an active state.

19. The UE of claim 14, wherein the fourth transition time is calculated by subtracting the third transition time from the wakeup transition time.
